(19) United States
(12) Patent Application Publication
(10) Pub. No.: US 2006/0236369 A1
(43) Pub. Date: Oct. 19, 2006

(54) Method, apparatus and system for enforcing access control policies using contextual attributes

(76) Inventors: Michael J. Covington, Hillsboro, OR (US); Manoj R. Sastry, Portland, OR (US)

Correspondence Address: INTEL CORPORATION, P.O. BOX 5326, SANTA CLARA, CA, 95056-5326, US

(21) Appl. No.: 11/317,879

(22) Filed: Dec. 21, 2005

Related U.S. Application Data
(63) Continuation-in-part of application No. 11/089,885, filed on Mar. 24, 2005.

(51) Int. Cl. H04L 9/00

(52) U.S. Cl. 726/1

(57) ABSTRACT

A method, apparatus and system provide access control utilizing contextual attributes. An access control module may receive a client request for access to a protected resource. The access control module may examine the contextual attributes associated with the request and compare the attributes against a policy database. If the attributes are valid according to a policy in the policy database, access may be granted to the protected resource. Otherwise, access may be denied.

### RELATED APPLICATIONS

The present application is a continuation-in-part of co-pending patent application U.S. application Ser. No. 11/089,885 (Atty Docket Number 42390.P21001), entitled “Method for Enabling Authentication Without Requiring User Identity Information”, filed on Mar. 24, 2005, and assigned to the assignee of the present application.

### BACKGROUND

1. Field

The present invention relates generally to computer security and, more specifically, to enforcing access control policies based on contextual attributes rather than relying solely on user identity information.

2. Description

Authentication is a fundamental building block in any system that enforces a security policy; it enables users to identify themselves to the system and provides a basis for access control. All authentication schemes follow the same basic approach: known identification information about a user is compared with information received from a source claiming to be that user. Authentication is successful if both pieces of information match. However, authentication failure will result if a match cannot be produced.

The traditional approach to authentication implies that users must present identity information. However, there are situations in which verification of specific user identity information is neither practical nor appropriate. For example, a wireless Internet service provider (ISP) may care about a user's location (e.g., the user is physically seated in a WiFi-enabled restaurant) and not his or her specific user identity. Further, the traditional approach to authentication reveals user privacy information, which may not be necessary to get authenticated in some scenarios.

Similarly, in traditional authorization or access control models, users and objects must typically be known a priori in order to define a policy. As a result, within a dynamic computing environment where users and resources may be constantly changing, these traditional schemes are highly limiting. For instance, in the example above where a user is physically seated in a Wi-Fi-enabled restaurant (i.e., a restaurant that has partnered with an ISP to provide wireless online services), the restaurant may wish to provide premium online services to a large number of users, without requiring advance registration. The restaurant may, however, want to construct varying levels of access for different types of users. Existing access control schemes may result in the restaurant and/or ISP incurring significant overhead to define and manage the authorization process.

### BRIEF DESCRIPTION OF THE DRAWINGS

The present invention is illustrated by way of example and not limitation in the figures of the accompanying drawings in which like references indicate similar elements, and in which:

FIG. 1 is a diagram of example data flows between a client device and a service provider using contextual attributes according to an embodiment of the present invention;

FIG. 2 is a diagram of an example authentication system using contextual attributes according to an embodiment of the present invention;

FIG. 3 is a diagram of an example access control system using contextual attributes according to an embodiment of the present invention;

FIG. 4 is a flow diagram illustrating authentication processing using contextual attributes; and

FIG. 5 is a flow diagram illustrating access control using contextual attributes according to an embodiment of the present invention.

### DETAILED DESCRIPTION

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

According to embodiments of the present invention, contextual information may be utilized to perform authentication and determine authorization. For the purposes of this specification, “authentication” may include any process by which a user is verified (i.e., verifying that someone is who they claim they are), including the use of a username and a password, but may include any other method of demonstrating identity, such as a smart card, retina scan, voice recognition, or fingerprints. Additionally, for the purposes of this specification, “authorization” includes the process of determining if an individual, once identified, is permitted to have access to the resource. The process of authorization, also referred to as access control, is typically implemented by determining if the individual has been granted explicit rights to access a resource, if the individual is a part of a particular group that has rights to a resource. The terms “authorization” and “access control” may be used interchangeably in the present specification.

Embodiments of the present invention take advantage of contextual information associated with users and their operating environment (e.g., resources and/or transactions requested). Given the abundance of information available to describe these users and their operating environment, there are certain scenarios in which contextual information may be more relevant than the user's unique identity for purposes of authentication and access control. Authentication and/or access control based solely on a user's contextual information according to embodiments of the present invention provides at least two benefits over existing usage models. First, user privacy is protected since embodiments of the present invention do not require the user to reveal personal identity information. Second, service providers benefit from reduced overhead due to simplified authentication and access control policy management.

Embodiments of the present invention comprise schemes to achieve authentication and enforce access control without requiring specific identity information from the user. Instead of identifying the user, the context in which the user makes the request is determined. Context, as used herein, includes the physical environment at issue (e.g., ambient noise level, brightness, air temperature, atmospheric pressure, time, etc.), attributes relevant to a pending transaction that the user is involved in (e.g., an electronic receipt), and non-unique attributes about the user (e.g., the user's current location).

In various embodiments, the contextual attributes may be associated with the user making the access request (subject of the request), the resource being accessed (the object of the request) and/or the requested transaction itself. Additionally, various types of contextual attributes may be utilized, including identification attributes, implicit attributes and/or explicit attributes and any reference herein to “contextual attributes” shall include at least these types of attributes. Thus, for example, identification attributes may refer to attributes that uniquely identify the subject or object (e.g., a username “Bob” or object reference “filename.txt”), implicit attributes may be non-unique attributes that may be assigned to the user or object (e.g., location, badge type) and explicit attributes may be unique transaction-specific attributes that may be collected or observed by the subject or object (e.g., tokens such as an e-receipt or a capability that is maintained by the user).

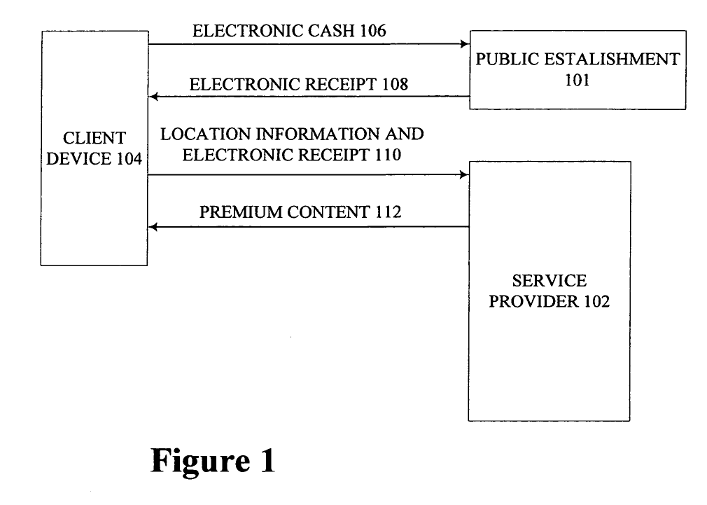

Consider a scenario such as is shown in FIG. 1, in which a public establishment 101 such as a coffee shop, for example, has partnered with a premium content Internet service provider 102 to provide access (perhaps for free) to premium content to customers who have made a purchase and remain physically located in the coffee shop. In at least one embodiment, the establishment and the service provider are separate entities and are not co-located. In order to access the premium content via the wireless service, a customer (denoted “user” hereinafter) must provide proof that the user is physically located in the coffee shop and that the user has made a recent purchase. Initially, the user enters the coffee shop and uses some form of electronic cash stored in a mobile computing device operated by the user to purchase an item for sale, such as coffee for example. The mobile computing device may be any client device 104 used for computing or telecommunication, such as a portable computer, personal digital assistant (PDA), cellular telephone, or messaging device, for example. In the system 100 shown in FIG. 1, the client device 104 interacts with public establishment equipment 101 to engage in a transaction or communication.

In one example, the client device interacts with an electronic cash register operated by the establishment to make a purchase. In this example, the user makes the purchase by communicating data representing electronic cash 106 from the client device 104 to the establishment 101. In return, the client device receives an electronic receipt 108 from the establishment indicating proof of purchase. The electronic receipt comprises a set of data (purchase information) representing the transaction (e.g., one or more of date, time, purchase amount, items purchased and so on) that may be stored in the client device. The purchase information may comprise data regarding any purchase by the user and/or the client device of at least one of goods and services from the establishment. In another example, a purchase may not be required and the establishment may provide an electronic token instead of an electronic receipt to the client device.

While enjoying the purchase, the user may wish to take advantage of premium content available for download to wireless client devices operated by current customers of the establishment. However, the user may desire to obtain the premium content without divulging personal information to the service provider, such as identity. In this case, in one example of using contextual attributes, the client device may provide the current geographic location of the client device and the electronic receipt (collectively denoted 110 in FIG. 1) to the service provider equipment. In one example, the combination of the current location within the premises of the establishment and the electronic receipt may comprise sufficient information to authenticate the user to the premium content service provider. In response, the service provider 102 enables access to premium content 112 for the client device. In one embodiment, the premium content may be an audio stream or file (e.g., current hit songs), an audio-video stream or file (e.g., music videos, movie clips, television programs, etc.), selected web pages, or other valuable information.

In this embodiment, the geographic location of the client device and possession of an electronic receipt (or other token) are the contextual attributes required for the user's authentication to the premium content service provider. No other information, such as a user name and password, or other identity information, is required to authenticate the user and allow access to the premium content.

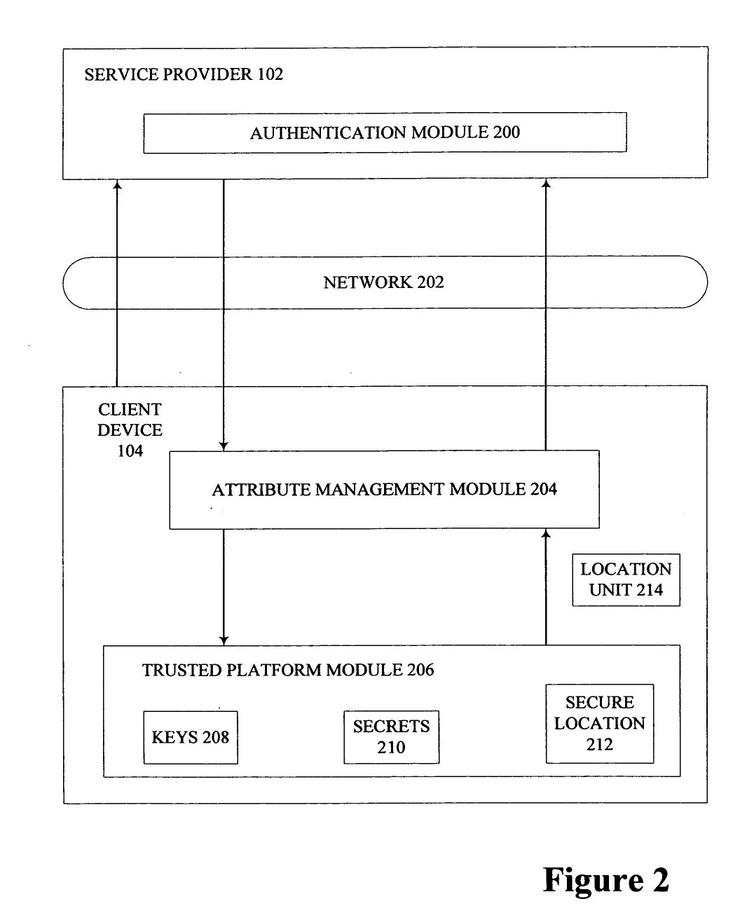

FIG. 2 is a diagram of an example authentication system using contextual attributes according to an embodiment of the present invention. On the server side, a service provider 102 comprises at least a computer server system including an authentication module 200 implemented in one or more of software, firmware, and hardware. The authentication module reviews policies determining access and usage of premium content available from the service provider and provides the client device 104 with a challenge that must be met in order to achieve authentication. In response, the client device sends an answer to the challenge that may be authenticated by the authentication module of the service provider. If the answer is acceptable according to the policy, access to premium content may be granted. The service provider may communicate with the client device over a network 202. In one embodiment, the network is the Internet, and the communication between the service provider and the client device takes place wirelessly according to any one of several well-known wireless protocols. In other embodiments, other networks may be used. Service provider 102 includes other well-known components omitted from FIG. 2 for clarity.

On the client side, an attribute management module 204 interacts with the authentication module 200 to provide necessary information to the service provider in order to be given access to the premium content or authenticated for other purposes. The attribute management module may be implemented in one or more of software, firmware, and hardware. In one embodiment, the attribute management module collects and manages trusted contextual attributes of the client device. The contextual attributes should be protected on the client device to deter unauthorized changes to the attributes in order to obtain benefits or access to content. The attribute management module 204 communicates with a trusted platform module (TPM) 206 residing on the client device. The TPM provides a foundation for trust and contains at least one or more of cryptographic keys 208, protected secrets 210, and secure location data 212.

Secure location data may be obtained by location unit 214. In one embodiment, the secure location data may comprise global positioning service (GPS) data and the GPS data may be obtained from a GPS receiver functioning as the location unit residing on the client device. In the embodiment wherein the location unit comprises a GPS receiver, the GPS receiver operates according to well-known methods to determine a geographic location. In other embodiments, other well known methods of determining location of the client device by the location unit may be used.

The TPM protects the data stored therein from attempts to gain unauthorized access according to well-known methods as described in relevant specifications of the Trusted Computing Group (TCG). The attribute management module 204 collects contextual attributes (such as protected secrets 210, and current geographic location information (secure location data 212)), and may have the contextual attributes digitally signed by an attestation identity key (AIK), which may be one of the cryptographic keys 208 securely stored in the TPM. Client device 104 includes other well-known components omitted from FIG. 2 for clarity.

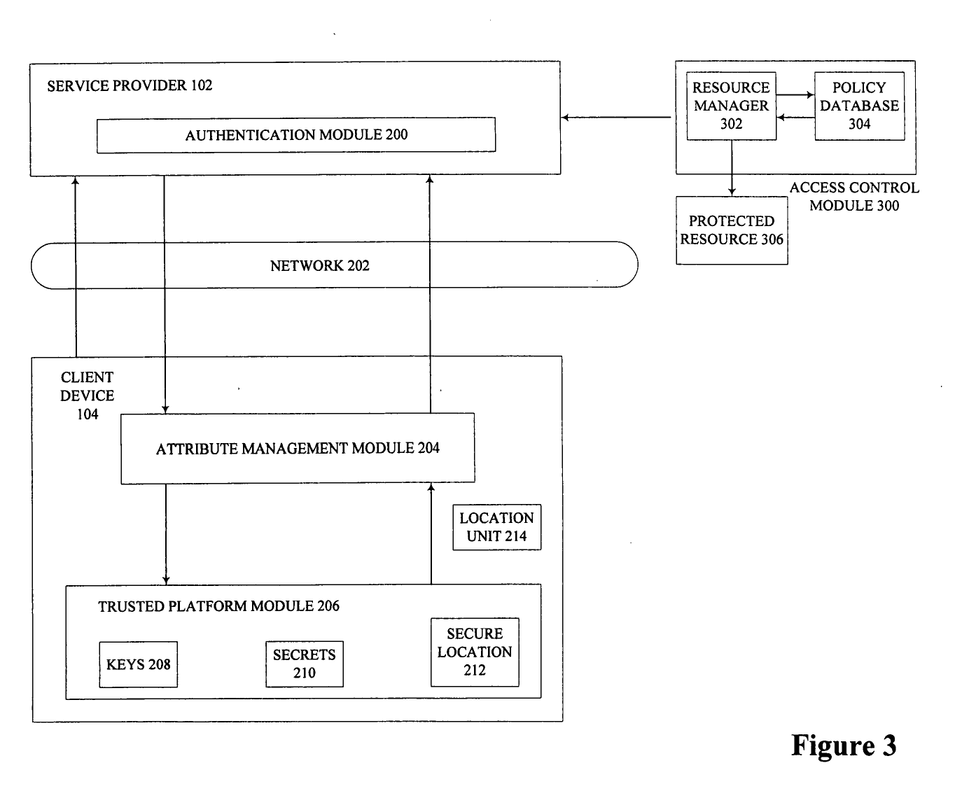

FIG. 3 is a diagram of an example access control system using contextual attributes according to an embodiment of the present invention. In one embodiment, this system may be implemented together with an authentication system as described above. Alternatively, however, an access control system according to an embodiment of the present invention may be implemented with other authentication schemes that do not utilize contextual attributes. While the latter access control system may lack some of the benefits provided by the authentication scheme that utilizes contextual attributes, it may nonetheless provide significant flexibility to a service provider by eliminating the need for users' personal information.

As illustrated, FIG. 3 includes all components of FIG. 2 and an access control component 300. As previously described, alternative embodiments may implement a different authentication scheme, but for the purposes of simplicity, the following example assumes the use of the authentication scheme described in FIG. 2. Access control component 300 may comprise various sub-components, including a resource manager 302 and a policy database 304. In one embodiment, upon authentication of the request as described above or according to alternate secure schemes, the request may be passed to access control component 300. The request may include the contextual attributes previously collected (by attribute management module 204 or a comparable module). In one embodiment of the present invention, access control component 300 may utilize the contextual attributes to enforce access control, i.e., to provide authorization to a request.

Thus, in one embodiment, upon receipt of the request, resource manager 302 may examine the contextual attributes. As previously described, the contextual attributes may be associated with the user making the access request (subject of the request), the resource being accessed (the object of the request) and/or the requested transaction itself. In one embodiment of the invention, the client request may include a “tuple” comprising the object, subject and/or the requested transaction.

Resource manager 302 may utilize the contextual attributes to query policy database 304, to determine whether authorization is to be allowed. If policy database 304 determines that the incoming request matches an “allowed” policy statement, access to protected resource 306 is granted. Thus, for example, the following is an example of a policy statement according to an embodiment of the present invention for the coffee shop scenario described above. For the purposes of illustration, an XML-type representation is used to outline the individual components that comprise the example policy statement:

```
<ABAC Policy>
  <Subject>
    <Ident> Not Required
    <Implicit>
      Location = Coffee Shop
    </Implicit>
    <Explicit>
      $0 < Purchase Amount < $5
      Time of Access < Time of Purchase + 30 minutes
    </Explicit>
  </Subject>
  <Object>
    <Ident> Not Required
    <Implicit>
      Content = Wall Street Journal Online
    </Implicit>
  </Object>
  <Permission>
    ALLOW
  </Permission>
</ABAC Policy>
```

In this example, the subject must be physically at the coffee shop (an implicit attribute), with a valid e-receipt (provided explicitly by the user) that indicates a purchase amount less than $5. Any user matching these properties will be granted access to the Wall Street Journal Online for 30 minutes from the time of purchase. If all of these conditions are met, access to the premium content (protected resource 306) will be allowed. It will be readily apparent to those of ordinary skill in the art that protected resource 306 may reside in a variety of locations without impacting embodiments of the present invention. Thus, in one embodiment, protected resource 306 may reside on a device at service provider 102. More likely, however, is an embodiment in which protected resource 306 resides at a remote location on Network 202.

Thus, embodiments of the present invention provide various advantages over current access control models. Most importantly, embodiments of the invention are uniquely suited to dynamic computing environments, as compared to existing access control models that typically utilize static concepts (user identities, object names, subject roles, etc.). Additionally, by utilizing contextual attributes, embodiments of the invention provide for less administrative overhead for defining and managing access policies. As illustrated in the example policy statement above, service providers may define intricate policies applicable to large groups of users because higher level policy may more easily be mapped into lower level system rules using contextual attributes. These policy statements enable the service providers significant flexibility because the providers are not limited to using pre-defined entities in policy specifications, therefore requiring less management overhead.

Embodiments of the invention also enhance service providers' ability to protect user privacy by using contextual attributes instead of personal identity information. They additionally enable new business models by providing companies with increased flexibility to provide services and/or rewards. Thus, for example, as previously described in the background, in a WiFi-enabled restaurant that currently partners with an ISP to offer free wireless internet to paying customers, all customers typically get the same default level of service. According to embodiments of the present invention, however, the ISP would have the flexibility of easily defining rich, fine-grained access control policies that provide different levels of access based on contextual attributes. For example, different levels of services may be provided based on the purchase amounts, frequency of purchases or visits to the establishment, etc.

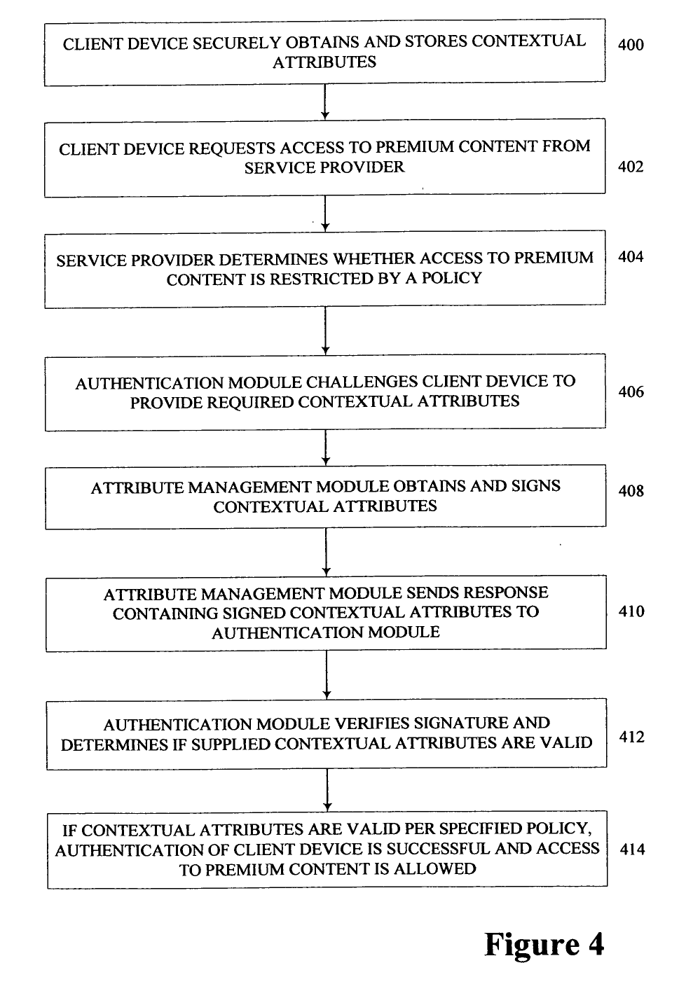

FIG. 4 is a flow diagram illustrating authentication processing using contextual attributes according to an embodiment of the present invention. A user may be operating a wireless communication enabled client device within the wireless range of a service provider's establishment. While there, the attribute management module 204 of the client device may securely obtain and store contextual attributes at block 300. The contextual attributes may comprise many different items of information about the current environment of the client device. For example, contextual information may include one or more of geographic location, air temperature at that geographic location, user purchase information, ambient noise level at the location, brightness of the environment at the location, current weather conditions other than temperature such as atmospheric pressure, velocity of movement of the client device, current processing load of the processing unit of the client device, available battery power of the client device, and current communications load between client devices and the service provider.

Other contextual attributes may also be used within the scope of embodiments of the present invention. The contextual attributes may comprise data not explicitly generated by the user. To obtain some contextual attributes, additional components or circuitry may be included in the client device (e.g., a location unit such as a GPS receiver, for example, for determining geographic location, a microphone for capturing ambient noise level, a camera for obtaining brightness, a thermometer for determining temperature, a barometer for determining pressure, and so on). The contextual attributes may be stored by the attribute management module in the TPM 206 to deter tampering with the data. The activity of obtaining and storing contextual attributes may be continuously performed by the client device regardless of its current operating mode, may be performed periodically according to a schedule, or may in some embodiments be performed at the explicit direction of the user.

At block 402, when the user operates the client device within or near an establishment within range of the service provider and is made aware of the potential availability of premium content through any means, the client device may request access to the premium content from the service provider. In one embodiment, this may involve sending a communications packet wirelessly from the client device to the service provider using well-known techniques. Alternatively, the client device may sense a signal offering service from the service provider once the client device is brought within range of the service provider's signal. At block 404, upon receiving the access request from the client device, the service provider in one embodiment determines whether the requested access to the premium content is restricted by a selected access policy. An access policy may be a set of rules governing access to the service provider's data, for example, premium content. There may be many different access policies for a service provider as well as a mechanism for selecting a given applicable access policy.

If the access policy allows unrestricted access, then the service provider may allow access by the client device. If the access policy does not allow unrestricted access, then the service provider may invoke the authentication module 200 to verify the source of the request. In embodiments of the present invention, the security decision on whether to allow access or not may be based on contextual attributes. The policy may be set up so as to require a selected set of data to be obtained from the client device. For example, in one embodiment, the access policy may require that the client device be physically located with 50 feet of the service provider and that the client device has an electronic receipt indicating a recent purchase of at least $2 of merchandise from the establishment of the service provider. This example is illustrative only and other access policies based on many other contextual attributes are contemplated and all are within the scope of the present invention.

Hence, at block 406 the authentication module may challenge the client device to provide the contextual attributes required by the selected access policy. For the client device's answer, the attribute management module at block 408 obtains the required contextual attributes from the TPM and, in one embodiment, digitally signs the contextual attributes using one of the cryptographic keys stored in the TPM, such as the attestation identity key (AIK), for example, according to well-known TPM signing processes.

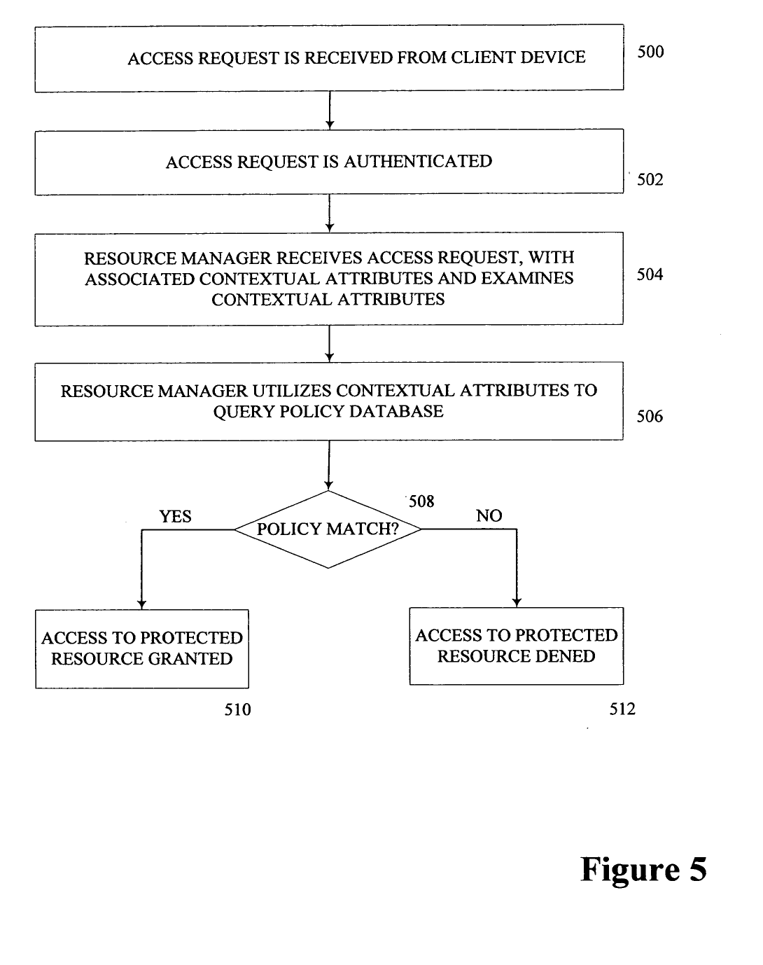

Next, the attribute management module at block 410 sends a response containing the signed contextual attributes to the authentication module of the service provider. Upon receiving the client device's response, the authentication module at block 412 verifies the signature on the response and then determines if the client device's supplied contextual attributes are valid according to the selected access policy (that is, if the attributes meet the requirements of the policy). If the attributes are valid and conform to the selected access policy, then authentication of the client device is successful and access to the premium content or other data may be enabled at block 414. If the attributes are not valid according to the policy, access may be denied. Further details of an access control policy according to an embodiment of the present invention are described below, with respect to FIG. 5.

FIG. 5 is a flow diagram illustrating access control processing using contextual attributes according to an embodiment of the present invention. As described above, an access control scheme may typically be used with an authentication scheme to determine whether a user request is authorized. In other words, although an authentication scheme may verify a request based on contextual attributes, the permissions associated with the request remains to be determined by the access control policy. In the scheme described above, the access control policy may not itself utilize contextual attributes but may instead challenge the authentication scheme to provide specific information to determine appropriate access to resources.

According to embodiments of the present invention, however, contextual attributes may be utilized directly by an access control scheme to determine access to resources. For the purposes of illustration, the example scenario described above with respect to the authentication scheme continues to hold true, i.e., a user may be operating a wireless communication enabled client device within the wireless range of a service provider's establishment and attribute management module 204 of the client device or a comparable module may securely obtain and store contextual attributes. Thus, an access request may be received from the client device at block 500 and authenticated in block 502.

According to one embodiment, the authentication scheme utilizes is the scheme described above while in an alternate embodiment, other authentication schemes may be utilized. In block 504, in one embodiment of the invention, the authenticated request may be received by resource manager 302 together with the contextual attributes associated with the request, and the contextual attributes may be examined. As previously described, the contextual attributes may be associated with the user making the access request (subject of the request), the resource being accessed (the object of the request) and/or the requested transaction itself and may include various types of attributes (identification attributes, implicit attributes and/or explicit attributes).

In block 506, resource manager 302 may utilize the contextual attributes to query policy database 304, to determine whether authorization is to be allowed. If policy database 304 determines in 508 that the incoming request matches an “allowed” policy statement, access to the protected resource is granted in 510. Thus, for example, if the policy specifies that to be granted access to the Wall Street Journal Online for 30 minutes from the time of purchase, the subject must be physically at a particular location (an implicit attribute), with a valid e-receipt (provided explicitly by the user) that indicates a purchase amount less than $5, any user request matching these properties may be allows access to the premium content. If the contextual attributes are not valid according to the policy, access may be denied in block 512.

Thus, embodiments of the present invention describe methods for achieving authentication and/or enforcing access control policies without requiring the user to reveal user identity information. In this case, authentication and/or access control may be achieved using trusted contextual attributes firmly rooted in the TPM of the client device. Although the term TPM is used through this application, embodiments of the invention are not so limited. Instead, any type of root of trust mechanism may be utilized without departing from the spirit of embodiments of the invention. Since the concept of root of trust is well known to those of ordinary skill in the art, further description thereof is omitted herein in order not to unnecessarily obscure embodiments of the invention.

Although the operations described herein may be described as a sequential process, some of the operations may in fact be performed in parallel or concurrently. In addition, in some embodiments the order of the operations may be rearranged without departing from the spirit of the invention.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components.

The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method comprising:
receiving a request for access to a protected resource;
receiving contextual attributes associated with the request;
comparing the contextual attributes against a policy database; and
granting access if the contextual attributes are valid according to a policy in the policy database.

2. The method according to claim 1 further comprising authenticating the request for access prior to comparing the contextual attributes against a policy database.

3. The method according to claim 2 wherein authenticating the request comprises authenticating the contextual attributes associated with the request.

4. The method according to claim 1 wherein the contextual attributes comprise at least one of information about a subject of the request, information about the protected resource and information about a type of transaction pertaining to the request.

5. The method according to claim 1 wherein the contextual attributes comprise a type and the type includes at least one of an identification attribute, an implicit attribute and an explicit attribute.

6. The method according to claim 1 wherein the policy in the policy database includes a at least one policy statement defined by at least one contextual attribute.

7. The method according to claim 1 wherein the contextual attributes include at least one of ambient noise level, brightness, air temperature, atmospheric pressure, time, an electronic receipt and a location.

8. An article comprising a machine-accessible medium having stored thereon instructions that, when executed by a machine, cause the machine to:
receive a request for access to a protected resource;
receive contextual attributes associated with the request;
compare the contextual attributes against a policy database; and
grant access if the contextual attributes are valid according to a policy in the policy database.

9. The article according to claim 8 wherein the instructions, when executed by the machine, further cause the machine to authenticate the request for access prior to comparing the contextual attributes against a policy database.

10. The article according to claim 9 wherein the instructions, when executed by the machine, further cause the machine to authenticate the request by authenticating the contextual attributes associated with the request.

11. The article according to claim 8 wherein the contextual attributes comprise at least one of information about a subject of the request, information about the protected resource and information about a type of transaction pertaining to the request.

12. The article according to claim 8 wherein the contextual attributes comprise a type and the type includes at least one of an identification attribute, an implicit attribute and an explicit attribute.

13. The article according to claim 8 wherein the policy in the policy database includes at least one policy statement defined by at least one contextual attribute.

14. A method comprising:
requesting access to a protected resource;
collecting contextual attributes associated with the request, the contextual attributes comprising at least one of information about a subject of the request, information about the protected resource and information about a type of transaction pertaining to the request, the contextual attributes further comprising a type and the type including at least one of an identification attribute, an implicit attribute and an explicit attribute;
transmitting the contextual attributes with the request.

15. The method according to claim 14 wherein collecting contextual attributes further comprises retrieving the contextual information from a trusted platform.

16. The method according to claim 14 further comprising receiving authorization to access the protected resource if the contextual attributes transmitted with the request match a policy in a policy database.

17. An article comprising a machine-accessible medium having stored thereon instructions that, when executed by a machine, cause the machine to:
request access to a protected resource;
collect contextual attributes associated with the request, the contextual attributes comprising at least one of information about a subject of the request, information about the protected resource and information about a type of transaction pertaining to the request, the contextual attributes further comprising a type and the type including at least one of an identification attribute, an implicit attribute and an explicit attribute;
transmit the contextual attributes with the request.

18. The article according to claim 17 wherein the instructions, when executed by the machine, further cause the machine to collect contextual attributes by retrieving the contextual information from a trusted platform.

19. The article according to claim 17 wherein the instructions, when executed by the machine, further cause the machine to receive authorization to access the protected resource if the contextual attributes transmitted with the request match a policy in a policy database.

20. An access control system comprising:
a client device capable of transmitting a request to a service provider requesting access to a protected resources, the client device further capable of transmitting contextual information with the access request; and
a resource manager of the service provider capable of receiving the request from the client device for access to the protected resources, the resource manager capable of comparing the received contextual attributes against a policy database and granting access to the protected resource if the contextual attributes are valid according to a policy in the policy database.

21. The access control system of claim 20 wherein the contextual information comprises at least one of information about a subject of the request, information about the protected resource and information about a type of transaction pertaining to the request.

22. The access control system of claim 21 wherein the contextual attributes comprise a type and the type includes at least one of an identification attribute, an implicit attribute and an explicit attribute.

23. The access control system of claim 20, wherein the client device further includes a trusted platform capable of storing the contextual attributes.
